(19) United States
(12) Patent Application Publication
(10) Pub. No.: US 2009/0097493 A1
(43) Pub. Date: Apr. 16, 2009

(54) QUEUING MIXED MESSAGES FOR CONFIGURABLE SEARCHING

(76) Inventors: Gururaja Patil, Hyderabad (IN); Swapnil Shambhu Kulkarni, Bangalore (IN)

Correspondence Address: WILLIAMS, MORGAN & AMERSON, 10333 RICHMOND, SUITE 1100, HOUSTON, TX, 77042, US

(21) Appl. No.: 11/871,540

(22) Filed: Oct. 12, 2007

(51) Int. Cl. H04L 12/28

(52) U.S. Cl. 370/412

(57) ABSTRACT

The present invention provides a method and an apparatus for forming a queue that enables a real time search of a first and a second plurality of messages which enter the queue in a linear order. The method comprises providing a sequential data structure to populate the queue with the first and second plurality of messages. The method comprises using the sequential data structure to selectively configure the queue for traversing in a search order different than the linear order in which the first and second plurality of messages reach the queue.

### BACKGROUND OF THE INVENTION

1. Field of the Invention

This invention relates generally to telecommunications, and more particularly, to wireless communications.

2. Description of the Related Art

Wireless communications systems or mobile telecommunication systems typically provide different types of services to various users or subscribers of wireless communication devices. The wireless communication devices may be mobile or fixed units and situated within a geographic region across one or more wireless networks. The users or subscribers of wireless communication devices, such as mobile stations (MSs) or access terminals or user equipment may constantly move within (and outside) particular wireless networks.

A wireless communications system generally includes one or more base stations (BSs) that can establish wireless communications links with mobile stations. Base stations may also be referred to as node-Bs or access networks. To form the wireless communications link between a mobile station and a base station, the mobile station accesses a list of available channels/carriers broadcast by the base station. To this end, a wireless communications system, such as a spread spectrum wireless communications system, may allow multiple users to transmit simultaneously within the same wideband radio channel, enabling a frequency re-use based on a spread spectrum technique.

In a wireless communications system, for a radio network controller (RNC), such as a 1xEVDO protocol based controller, various network elements may perform call processing and logging. A call processing subsystem may receive messages from different sources. The call processing subsystem may comprise a message server to forward information destined for a read-only-printer (ROP). The message server converts the information from raw data to user readable format that can be printed on the ROP, a module using a network management protocol may forward the informational traps from the message server to the ROP. The call processing subsystem may log different kinds of errors including exceptions or assertions to report to the ROP. For example, the message server may report occurrences of Call Processing (CP) exceptions and Asserts to the ROP within a given period of time, such as every second.

Generally, these messages may be buffered in a queue based on a linked list (LL) for searching. However, a standard may impose certain requirements, such as limits over the number of CP Exception and Assert messages than can be sent to the ROP by the message server in a given second. The messages may be buffered in a queue based on a linked list (LL). However, a linear search of a mixed set of messages may result in an inefficient implementation at the message server. That is, when searching the queue of messages in a linear manner, performance of the LL both in terms of time and memory space usage may be inadequate for a real time environment of rapidly changing input data associated with the messages arriving from, e.g., the 1xEVDO radio network controller in a wireless communications system.

Referring to FIG. 2, forming of a single conventional queue 200 for searching within a linked list 205 of mixed messages is schematically illustrated in consecutive intervals of time. In response to a search request, a message search engine may search for a particular message within the linked list 205 of mixed messages including a first type of messages 210a, Call Processing (CP) exceptions (CPEXCP1-15) and a second type of messages 210b, Assert1-4. The message search engine may search the queue 200 in multiple consecutive intervals of time in response to the search request. As an example, a linear search is shown by an arrow 215 within the linked list 205. The message search engine may begin a search at a given time interval, such as T=1, the CP exceptions messages CPEXCP1-15 and the Assert1-4 messages. A first message threshold may be set for first type of messages CP exception, for example, as CPEXCP1-5, and a second message threshold may be set for the second type of messages, Assert1-4, as Assert1-3.

A buffer may store and maintain the first and second type of messages 210a, 210b to enable the linear search 215 within the queue 200(1). For example, a first-in first-out (FIFO) algorithm for the message search engine may search the queue 200(1). The algorithm may maintain a separate counter for both types of messages including CP exceptions 210a and Asserts 210b. In the queue 200(1), the linked list 205 may enable the message search engine to perform a search for the first type of messages CP exceptions 210a until a first message threshold 220 is reached.

When the first message threshold 220 is set as CPEXCP1-5, for example, upon reaching the first message threshold 220, a search may initiate for the second type of messages Asserts 210b. At the end of the search, one or more messages searched may be provided as an output from the queue 200(1). In other words, the message search engine upon reaching the first message threshold 220 starts searching for the second type of messages, Asserts 1-4, as shown by the an assert link 225. However, the linear search 215 still continues through the queue 200(1) via the first type of messages CP exceptions (CPEXCP8-9). That is, the search path or sequence within the linked list 205 does not transition from one type of messages to another type of messages upon reaching the first message threshold 220.

A link 230a indicates a successful search for a message and a second link 230b indicates an unsuccessful search. While the first link 230a may output a search result for the first type of messages 210a, the second link 230b results in an unsuccessful search for the time interval, T=1. In this way, the message search engine can only output the first type of message, CPEXCP6, in a subsequent interval of time, i.e., causing at least one another iteration.

Referring to FIG. 3, searching of the single conventional queue 200(1) is schematically depicted for searching within the linked list 205 of mixed messages. In particular, a queue 200(2) is shown within a buffer at a second time interval, e.g., T=2. In the second time interval, the first type of messages 210a that may be searched includes CPEXCP6-10 and the second type of messages 210b that may be searched includes Assert 4. After a forth instance or occurrence of the first message type CPEXCP 10, when the first message threshold is turned on, as shown by a link 220a indicates that the message search engine now initiates the linear search 215 for the second type of messages 210b. However, a link 220b indicates that the message search engine even after encountering the Assert 4 still continues further the linear search 215 for the second type of messages 210b to detect if any more of the second type of messages 210b have been queued in the queue 200(2).

A queue 200(3) shows a third time interval, T=3 for the buffer which only holds the remaining first type of messages 210a, i.e., CPEXCP11-15. As a result of the linear search 215, the search depends upon an order in which the first and second type of messages 210a-b arrive at the queue 200(1). That is, the message search engine searches through the first type of messages until a threshold for that message type is reached. Thereafter, a search for the second type of message can begin but the search still traverses through remaining first type of the messages in queue 200(1). Accordingly, an inefficient search may result due to higher processing time.

Referring to FIG. 4, a conventional, separate message queue is depicted for each type of messages 400 and an additional queue for storing the order of both types of messages. The separate queues 400 may buffer different message types along with another queue that commonly stores the order in which the messages arrive. In particular, a first message queue 400(1) and a second message queue 400(2), and an order queue 405, may enable searching of a particular message. While the first message queue 400(1) may hold the first type of messages 210a, CPEXCP1-4, the second message queue 400(2) may hold the second type of messages 210b, Assert 1-3 in a separate buffer.

The order queue 405 may maintain a pointer to each message for retrieval when sending that message to a message display device, such as a read only printer (ROP). As an example, a pointer 415 from the order queue 405 to a first message 420 of the first type of messages 210a is shown to the message queue 400(1). The message search engine may perform a search using a linear search order 215a within the order queue 405. Since this message search engine also uses a linear search, hence it is no more efficient in searching than the search engine set forth above in FIGS. 2 and 3. That is, the order queue 405 maintains an order list in which once a threshold for a particular kind of message is reached, the linear search order 215a still searches through all the queued messages to reach another kind of message. Moreover, the order queue 405 requires maintaining a separate order list, using additional memory space. Accordingly, a search based on the message search engine depicted in FIG. 4 may maintain many different queues and perform additional operations to insert and delete messages from the queues 400(1-2) and 405.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for forming a queue that enables a real time search of a first and a second plurality of messages that enter the queue in a linear order. The method comprises providing a sequential data structure to populate the queue with the first and second plurality of messages. The method comprises using the sequential data structure to selectively configure the queue for traversing in a search order different than the linear order in which the first and second plurality of messages reach the queue.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a wireless network controller that processes calls or messages for logging for a network operator in accordance with one embodiment of the present invention;

FIG. 2 schematically illustrates forming of a single conventional queue for searching within a linked list of mixed messages in multiple consecutive intervals of time by a message server in response to a search request;

FIG. 3 schematically depicts searching of the single conventional queue for searching from a linked list of mixed messages;

FIG. 4 schematically depicts conventional forming of separate queues for different message types and an additional queue for storing the order of messages;

FIG. 5 schematically depicts implementation of a method for forming the queue that enables a real time search of a first and a second plurality of messages in a desired search order according to one embodiment of the present invention;

FIG. 6 schematically depicts a queue based on a sequential data structure that enables multiple virtual linked lists of messages of same kind within the queue in accordance with one illustrative embodiment of the present invention; and

FIG. 7 illustrates schematically depicts the multiple virtual linked lists for traversing the queue in more than one path within the queue consistent with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally a method is provided for forming a queue that enables a real time search of a first and a second plurality of messages which enter the queue in a linear order. Examples of a message include messages, a piece of data or an information element or a component that a buffer may store and output in a real time during a given interval of time. A message server may queue a mix of at least two types of signaling messages associated with a wireless network using a sequential data structure. The sequential data structure may enable a user to form and customize multiple linked lists within a queue. For example, each type of message may result in a separate linked list that may be independently traversed when conducting a search for a particular message. By using the sequential data structure, a queue may be formed based on at least two independent linked lists. That is, using the sequential data structure, the message server may populate the queue in a first virtual linked list for the first plurality of messages and a second virtual linked list for the second plurality of messages within the same queue. In this way, a message server may search for one or more messages arriving in an order different than a linear order, such as a first-in first-out (FIFO) order in which the first and second plurality of messages reach a buffer storing the queue. A user, for example, network operator of a wireless network may configure the queue to provide selectively individual paths for different type of that arrive at the queue in addition to a linear order in which a first and a second plurality of messages of the mixed types of messages reach the queue. The message server may use a desired search order different than the linear order for traversing the queue and the search order may be changed on the fly based on one or more run time conditions. Examples of the run time conditions may include assertion of a limit for the first and/or second plurality of messages to be retrieved within the queue in a given time interval. For example, as long as the messages are within a threshold, a search request may follow the first virtual linked list, however, when a search request exhausts a limit on the first type of messages has been reached, search to the first type of messages terminates and the search jumps to a first instance or occurrence of the second type of message using the second virtual linked list. In other words, upon encountering a threshold for searching a particular type of message which is not being searched within the given time interval, the message server may jump to another type of messages. Thus, a search engine may search through the first type of messages until a threshold for that message type is reached within a given interval of time. Thereafter, a search for the second type of message may begin directly through the second type of messages by not traversing the remaining first type of messages within the given interval. Accordingly, a significantly efficient search may result due to relatively lower processing time than a linear search.

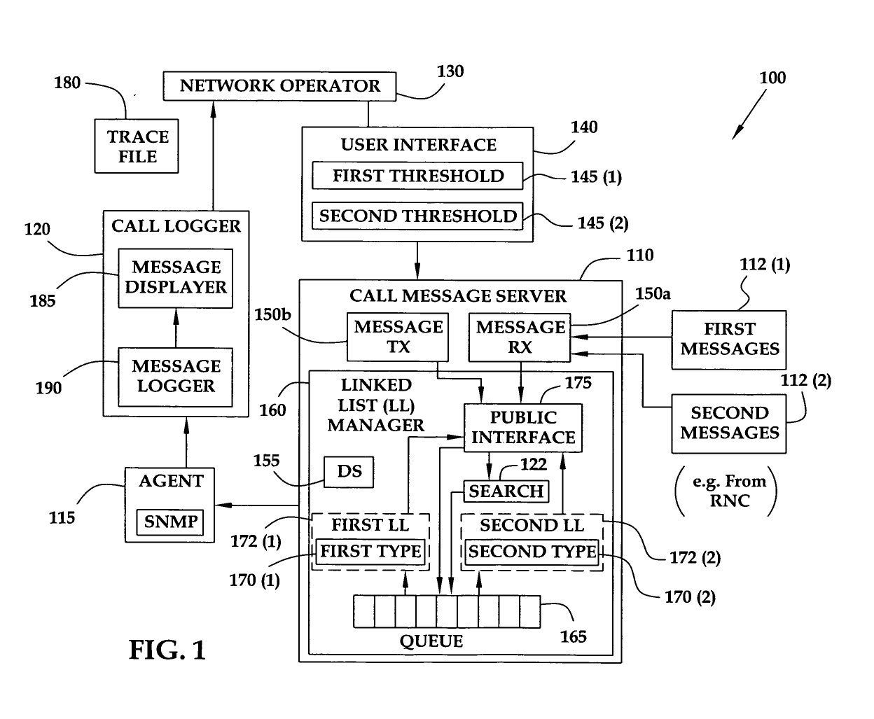

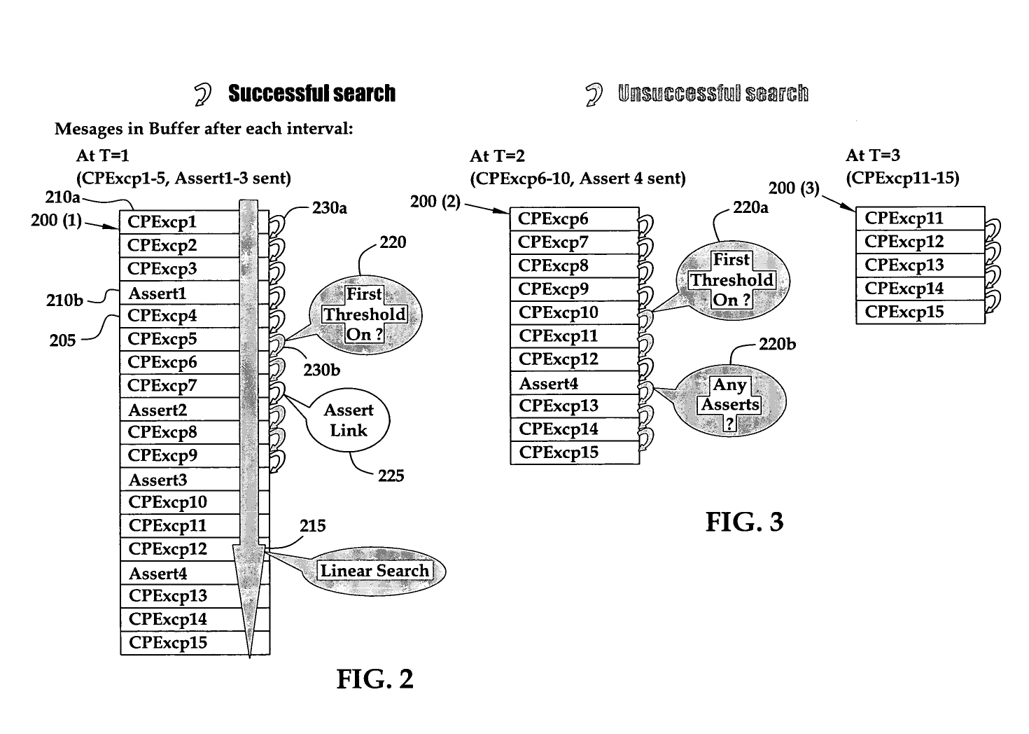

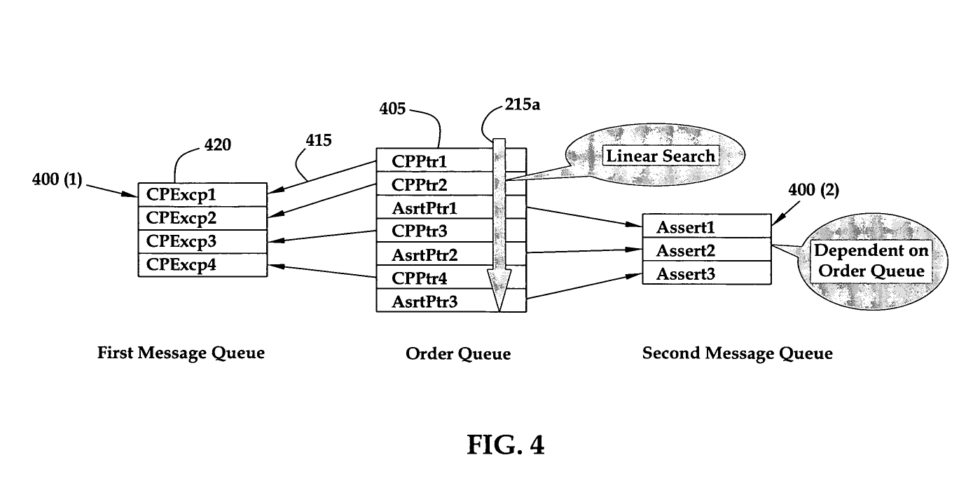

Referring to FIG. 1, a message server 100, such as associated with a wireless network includes a call message server 110 to receive a first and a second plurality of messages 112(1,2) from a conventional radio network controller (RNC) for further logging and reporting to in accordance with one embodiment of the present invention. The message server 100 may comprise an agent 115 coupled to a call logger 120. The agent 115 may use a protocol for network management, such as a simple network management protocol (SNMP) to send a message to the call logger 120 for display and reporting. The agent 115 may provide information associated with the first and second plurality of messages 112(1-2) that the call message server 110 queues to the call logger 120.

In response to a request for searching one or more messages of a particular type or kind, a search engine 122 may perform the search and the call logger 120 may display the logged first and second plurality of messages 112(1,2) for reporting to a network operator 130. The message server 100 may comprise a user interface 140 for the network operator 130 to interface with the call message server 110. By using the user interface 140, the network operator 130 may define a first threshold 145(1) that may indicate a limit on the number of first plurality of messages 112(1) to be searched within a given time interval and a second threshold 145(2) that indicates a limit on the number of the second plurality messages 112(2).

The call message server 110 may further comprise a message receiver module 150a and a message transmit (TX) module 150b. The message receive (RX) module 150a may receive the first and second plurality of messages 112(1-2) from the radio network controller. The message transmit (TX) module 150b may send the first and second plurality of messages 112(1,2) for logging to the call logger 120 through the agent 115.

To process the first and second plurality of messages 112(1-2), the call message server 110 may further comprise a linked list (LL) manager 160, which may control the queuing of the first and second plurality of message 112(1-2) arriving at the call message server 110. The linked list manager 160 may use a sequential data structure (DS) 155 to form a queue 165. The linked list manager 160 may enable searching of the queue 165 in a real time for one or more messages, for example, between a first type of messages 170(1) linked in a first list 172(1), and a second type of messages 170(2) linked in a second list 172(2). In one embodiment, while the first type of messages 170(1) refer to a signaling kind of messages associated with a phone call in the first plurality of messages 112(1), the second type of messages 170(2) refer to a signaling kind of messages that an access network may provide within the second plurality of messages 112(2).

Using the sequential data structure 155, the linked list manager 160 may populate the queue 165 with the first and second plurality of messages 112(1-2). In other words, the linked list manager 160 may build the first list 172(1) for the first type of messages 170(1) and the second list 172(2) for the second type of messages 170(2) within the queue 165. The linked list manager 160 may comprise a public interface 175, which provides access to the first and second lists 172(1-2) to retrieve a message from the queue 165 based on the first and second thresholds 145(1-2) set by the network operator 130.

Consistent with one embodiment of the present invention, the call logger 20 may provide a trace file 180 to the network operator 130. The trace file 180 may report logging information about the first and second plurality of messages 112(1-2). To this end, the call logger 20 may comprise a message displayer 185, e.g., a Read Only Printer (ROP) to display the messages 112(1,2) on the fly that may be arriving from the radio network controller. To log the messages 112(1,2), the call logger 120 may further comprise a message logger module 190. The message logger module 190 may receive message logging information from the agent 115 to provide the trace file 180 through the message displayer 185.

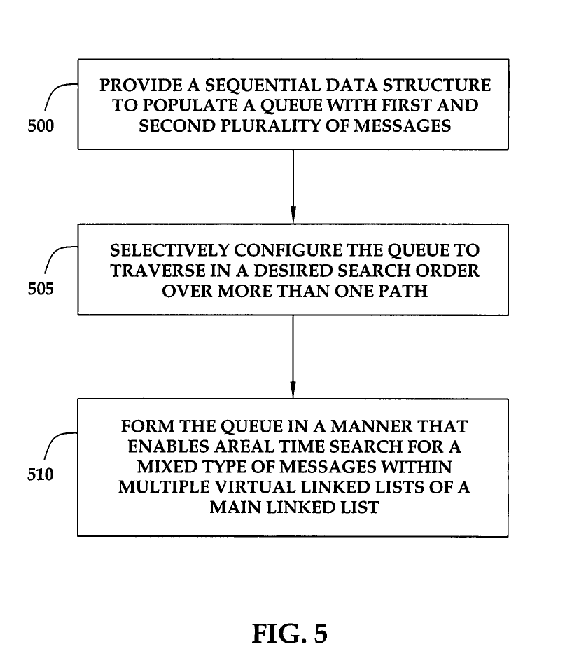

Referring to FIG. 5, a stylized representation for implementing a method of forming the queue 165, as shown in FIG. 1, that enables a real time search of the first and second plurality of messages 112(1,2) which may enter the queue 165 in a linear order is schematically illustrated according to one embodiment of the present invention. At step 500, the sequential data structure 155 may be provided to populate the queue 165 with the first and second plurality of messages 112(1,2). In block 505, the queue 165 may be selectively configured using the sequential data structure 155 for traversing in a search order different than the linear search order 215 in which the first and second plurality of messages 112(1,2) reach the queue 165. At block 510, the queue 165 may be formed in a manner which enables a real time search for a mixed type of messages. According to one embodiment of the present invention, examples of a real time condition include defining of thresholds or limits for the number of messages to be searched in a particular time interval in the queue 200(1).

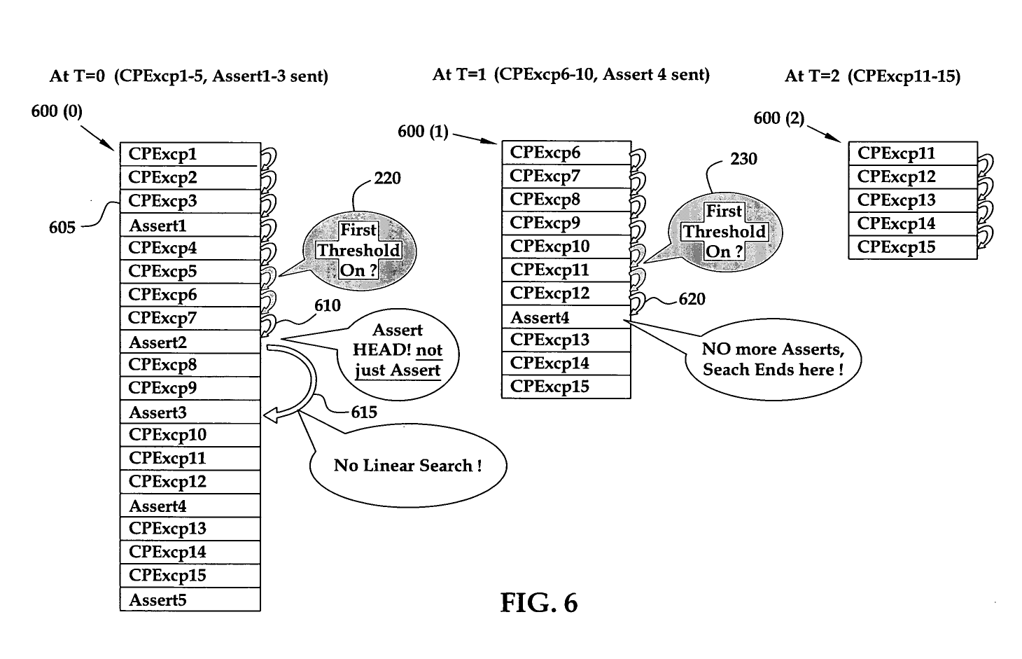

Referring to FIG. 6, a queue 600(0) based on the sequential data structure 155 shown in FIG. 1 is schematically depicted to enable forming multiple virtual linked lists of messages of the same type within the same queue 600(0) in accordance with one illustrative embodiment of the present invention. The sequential data structure 155 may maintain an additional pointer to each next instance of the same type of message within the queue 600(0). Using the additional pointer, the linked list manager 160 may form an individual virtual linked list of messages of the same type within the common queue 600(0).

In response to the search request, for the first type of messages 170(1), the linked list manager 160 may traverse the queue 600(0) in a main linked list 605 in a sequence based on a search order different than the linear search 215 order in which the first and second plurality of messages reach the queue 600(0).

The network operator 130 may define the main linked list 605 for queuing the first plurality of messages 112(1) in a first individual virtual linked list and the second plurality of messages 112(2) in a second individual virtual linked list. For traversing the queue 600(0) in a desired search order, other than the linear search 215 order, the network operator 130 may configure the first threshold 145(1) independent of the second threshold 145(2).

To traverse the queue 600(1), the linked list manager 160 may search for a first instance of the second type of message 210b during a given time interval, such as at time interval T=0. The linked list manager 160 may detect whether the first message threshold 220 is asserted for the first type of messages 210a. If so, upon receiving the search request, the linked list manager 160 may search the queue 600(0) such that once the first message threshold 220 is reached, the search order may jump to the first instance of the second type of messages 210b, as shown by a link 610.

In other words, the linked list manager 160 asserts that the first instance of the second type of message is reached if the first message threshold 220 is turned on, indicating that instance to be a head of the second type of messages 210b, i.e., Assert 2. Thereafter, the linked list manager 160 may change the linear search 215 order of search to the search order in which the search jumps directly to a second, e.g., subsequent instance of the second type of messages 210b, i.e., Assert 3, instead of traversing through the remaining first type of messages 210b, CPEXCP8-9, as shown by a link 615. The linked list manager 160 may detect whether the second message threshold 145(2) is reached for the second type of message 210b during the given time interval. If the second message threshold 145(2) is not reached, during the given time interval the manager may provide a desired instance of the second type of message 210b by traversing the queue 600(0) beyond the first message threshold 220 only to the location of the desired instance of the second type of message.

A queue 600(1) at a time interval, T=1, may end the search at the desired instance of the second type of messages 210b. The desired instance may be based upon an earlier occurrence of an indication of reaching the second message threshold 145(2) or upon an indication of absence of a message of the second plurality of messages 112(2) in the queue 600(1). A link 620 indicates that the search ends for the second type of messages 112(2) when the message Assert 4 is reached. A queue 600(2) may include only the first type of messages 210a, for example, at a time interval T=2, a buffer for the queue 600(2) may include the messages CPEXCP11-15.

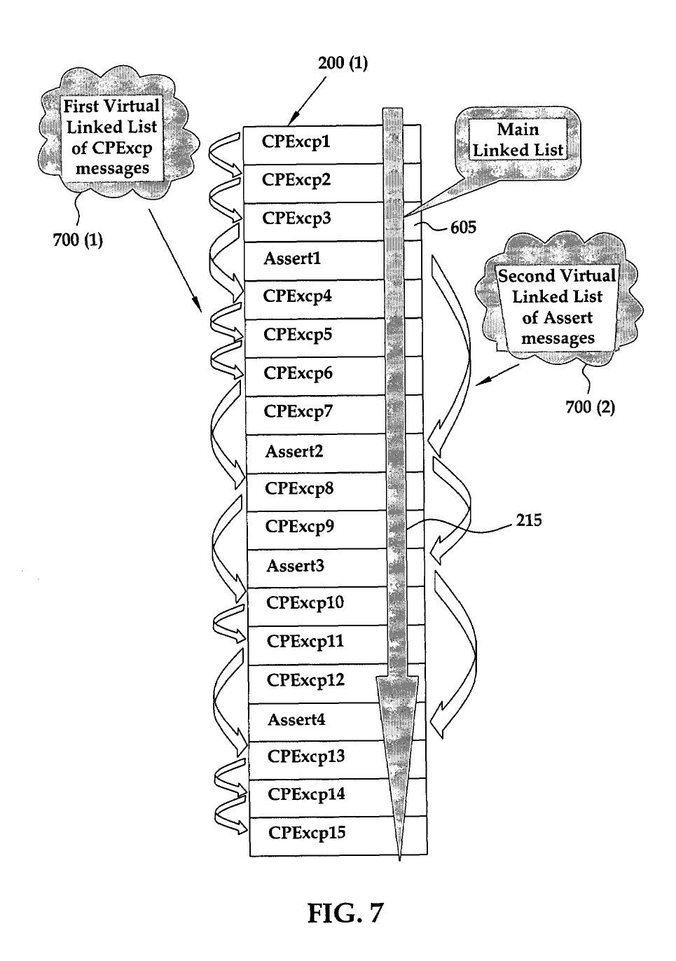

Referring to FIG. 7, a plurality of virtual linked lists 700 within the main linked list 605, e.g., a tripled linked list (TTL) shown in FIG. 6 may enable traversing of the queue 200(1) in more than one path consistent with one embodiment of the present invention. In particular, a first virtual link list 700(1) of the first plurality of messages 112(1) may provide a first individual path within the queue 200(1). Likewise, a second virtual linked list 700(2) may provide a second individual path within the queue 200(1). The first and second virtual linked list 700(1-2) may enable individual paths to traverse through the queue 200(1) based on the first and second virtual linked lists 700(1-2) in addition to a linear path for the linear order 215 on the main linked list 605.

In accordance with one illustrative embodiment of the present invention, the message server 100 may enable searching of the queue 200(1) for the first and second plurality of messages 112(1,2) that may reach from the radio network controller in a wireless communication system. The message server 100 may log the first and second plurality of messages 112(1,2) to provide a trace of call messages to a wireless, such as a cellular network operator or service provider. According to one embodiment of the present invention, the message server 100 may determine whether a search request is issued or asserted by the network operator 130 to determine a status of a call message logged by the call message logger 120. For example, the network operator 130 may use a read-only-printer (ROP) to display search results for a particular call message among a mixed set of messages that may be arriving from a wireless network that the network operator 130 manages in the wireless communication system.

To provide the sequential data structure 155 which enables forming of the queue 200(1) with the multiple virtual linked lists 70091-2), a plurality of pointers may be maintained by the linked list manager 160 in the message server 100. In particular, the linked list manager 160 may maintain a first pointer to a previous node in a link list for each of the first and second plurality of messages 112(1,2). Likewise, the linked list manager 160 may maintain a second pointer to a next node in the link list for each of the first and second plurality of messages 112(1,2). The second pointer may indicate the linear search 215 order in which the first and second plurality of messages 112(1,2) search in the queue 200(1).

Besides the first and second pointers, the linked list manger 160 may maintain a third pointer to a next message of same kind from each of the first and second plurality of messages 112(1,2). The third pointer may enable forming of the first virtual linked list 700(1). Likewise, the linked list manager 160 may maintain a third pointer of a next message for each of the second plurality of messages to enable forming of the second virtual linked list 700(2) for traversal in response to a search request. In addition, the linked list manager 160 may maintain a union of messages for the first and second plurality of messages 112(1,2).

The message server 100 may use the public interface 175 to the main linked list 605 for inserting and/or retrieving message(s) into the queue 200(1). To this end, the linked list manager 160 may maintain an array of nodes for the main linked list 605, in one embodiment of the present invention. In this way, the linked list manager 160 may enable the call logger 120 to traverse the main linked list 605 in a sequence based on a search order different than the linear search order 215 in which the first and second plurality of messages 112(1,2) reach or enter the queue 200(1).

In one embodiment, a cellular system may include the message server 100 to wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP2) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of forming a queue that enables a real time search of a first and a second plurality of messages that enter the queue in a linear order, the method comprising:
providing a sequential data structure to populate said queue with said first and said second plurality of messages; and
using said sequential data structure to selectively configure said queue for traversing in a search order different than said linear order in which said first and said second plurality of messages reach said queue.

2. A method, as set forth in claim 1, wherein providing a sequential data structure further comprises:
defining a pointer for said sequential data structure to queue said first plurality of messages in a first list and said second plurality of messages in a second list independent of said first list within said queue.

3. A method, as set forth in claim 2, further comprising:
defining a link list for queuing said first plurality of messages in said first list and said second plurality of messages in said second list; and
in response to a search request for at least one of said first and second plurality of messages, traversing said link list in a sequence based on said search order.

4. A method, as set forth in claim 3, further comprising:
defining a first thresholds to indicate a limit over the number of said first plurality of messages; and
defining a second threshold to indicate a limit over the number of second plurality of messages to be retrieved from said queue in a given time interval.

5. A method, as set forth in claim 4, further comprising:
configuring said first threshold independent of said second threshold for traversing said queue in said search order.

6. A method, as set forth in claim 5, further comprising:
logging said first and said second plurality of messages in a wireless communication system for a radio network controller.

7. A method, as set forth in claim 1, further comprising:
enabling a first virtual link list of said first plurality of messages; and
enabling a second virtual link list of said second plurality of messages within said queue.

8. A method, as set forth in claim 7, further comprising:
maintaining an additional pointer to a next element of the same kind of message for said first and said second plurality of messages within said queue.

9. A method, as set forth in claim 7, further comprising:
in response to a search request, enabling individual paths to traverse through said queue based on said first and second virtual link lists in addition to a linear path on said queue.

10. A method, as set forth in claim 9, further comprising:
traversing said queue to search a first instance of a second type of message during a given time interval;
detecting whether a first threshold is asserted for a first type of message; and
if said first threshold is asserted as is reached, providing said second type of message.

11. A method, as set forth in claim 10, further comprising:
indicating said first instance of said second type of message as a head of said second virtual link list.

12. A method, as set forth in claim 11, further comprising:
detecting whether said second threshold is reached for said second type of message during the given time interval; and
if said second threshold is not reached, during the given time interval providing a desired instance of said second type of message by traversing said queue beyond said first threshold only to the location of said desired instance of said second type of message.

13. A method, as set forth in claim 12, further comprising:
ending search at said desired instance of said second type of message in said queue, wherein said desired instance is based upon an earlier occurrence of an indication of reaching said second threshold or upon an indication of absence of a message of said second plurality of messages in said queue.

14. A method, as set forth in claim 7, further comprising:
in response to a search request, altering said sequence of search in said queue based on a real time condition.

15. A method, as set forth in claim 14, further comprising:
detecting occurrence of said real time condition.

16. A method, as set forth in claim 1, further comprising:
maintaining a first pointer to a previous node in a link list for each of said first and second plurality of messages.

17. A method, as set forth in claim 16, further comprising:
maintaining a second pointer to a next node in said link list for each of said first and said second plurality of messages to indicate said linear order in which said first and said second plurality of messages reach said queue.

18. A method, as set forth in claim 16, further comprising:
maintaining a third pointer to a next message of the same kind from each of said first plurality of messages to enable forming a first virtual linked list and from each of said second plurality of messages to enable forming a second virtual linked list for traversal within said queue.

19. A method, as set forth in claim 16, further comprising:
maintaining a union of messages for said first and said second plurality of messages.

20. A method, as set forth in claim 16, further comprising:
providing an interface to said link list to insert a message into said link list and to retrieve at least one message from said link list; and
maintaining an array of nodes for said link list.
